(19) United States
(12) Patent Application Publication
(10) Pub. No.: US 2005/0260467 A1
(43) Pub. Date: Nov. 24, 2005

(54) Electronically conductive reformer catalyst for a fuel cell and method for producing the same

(75) Inventors: Marc Bednarz, Ottobrunn (DE); Marc Steinfort, Aidlingen (DE)

Correspondence Address: OSTROLENK FABER GERB & SOFFEN, 1180 AVENUE OF THE AMERICAS, NEW YORK, NY, 100368403, US

(73) Assignee: MTU CFC Solutions GmbH, 85521 Ottobrunn (DE)

(21) Appl. No.: 10/525,880

(22) PCT Filed: Aug. 20, 2003
(86) PCT No.: PCT/EP03/09210

§ 371 Date: Mar. 21, 2005

(30) Foreign Application Priority Data
Aug. 24, 2002 (DE) 102 38 912.8

(51) Int. Cl. H01M 8/06; H01M 4/86

(52) U.S. Cl. 429/19; 429/44

(57) ABSTRACT

The invention relates to an electronically conductive reformer catalyst for a fuel cell, in particular a molten carbonate fuel cell, containing particles of a water-adsorbent substrate material (6) and particles of a catalyst material (7) located on said substrate material (6). According to the invention, the substrate material (6) itself is electronically conductive. The specific conductivity of the reformer catalyst (4) preferably exceeds 1 S/cm under operating conditions.

The invention concerns an electronically conductive reforming catalyst for a fuel cell, especially a molten carbonate fuel cell, which contains particles of a water-adsorbent substrate material and particles of a catalyst material located on the substrate material.

In fuel cells, especially molten carbonate fuel cells, catalysts are used for internal reforming of the fuel gas and are preferably incorporated in the anode compartment. In this connection, the catalysts, which are in the form of structures with a flat expanse, are placed between a bipolar separator that separates adjacent fuel cells and an anode current collector that is in electrical contact with the anode. This means that the catalyst must electronically connect the two aforementioned components of the fuel cell over its entire area.

Previously known internal reforming catalysts of this type generally consist of an electronically conductive substrate structure, which is capable of producing this electrical connection, and a catalyst material distributed among a large number of particles incorporated in the substrate material. For example, WO 97/49138 describes a catalyst assembly for internal reforming in a fuel cell, which contains a current collector made of an electrically conductive, metallic material with projecting regions spaced some distance apart and a catalyst material in the form of macroscopic particles distributed between the projecting regions. The projecting regions of the current collector form an electronically conductive connection between the bipolar separator and the anode of the fuel cell. U.S. Pat. No. 4,618,543 describes a reforming catalyst for internal reforming in a fuel cell, in which a catalyst material in the form of microscopic particles is incorporated in the cavities of a porous metallic material. The porous metallic material forms an electronically conductive connection between the bipolar separator and the anode of the fuel cell. the abstract of Japanese Patent Kokai No. 61[1986]-260,555 A describes a catalyst for internal reforming in a fuel cell, in which a catalyst layer is provided on one side of a conductive porous plate, whose other side has an electrode layer formed by a porous metal. A porous spacer layer that serves as a flow passage for the fuel gas is located between the catalyst layer and the conductive porous plate. Finally, the abstract of Japanese Patent Kokai No. 62[1987]-139,273 A describes a molten carbonate fuel cell, in which a metallic mesh or a metallic porous plate forms a core material of a reforming catalyst.

The objective of the invention is to develop an electronically conductive reforming catalyst for a fuel cell, especially a molten carbonate fuel cell, that can be produced easily and inexpensively.

This objective is achieved by the electronically conductive reforming catalyst specified in Claim 1. Preferred embodiments of this catalyst are specified in the dependent claims.

A further objective of the invention is the development of a method for producing an electronically conductive reforming catalyst of this type.

This method is specified in Claim 15. Preferred embodiments of the method of the invention are specified in the dependent claims.

Finally, another objective of the invention is the development of a fuel cell, especially a molten carbonate fuel cell, with an electronically conductive reforming catalyst that can be produced easily and inexpensively.

The invention creates an electronically conductive reforming catalyst for a fuel cell, especially a molten carbonate fuel cell. The reforming catalyst contains particles of a water-adsorbent substrate material and particles of a catalyst material located on the substrate material. In accordance with the invention, the substrate material itself is electronically conductive.

An important advantage of the reforming catalyst of the invention is that the amount of material needed for the anode current collector can be significantly reduced. Another advantage is that the reforming catalyst can be produced simply and inexpensively.

The specific conductivity of the reforming catalyst preferably exceeds 1 S/cm under operating conditions.

The substrate material preferably consists of an electronically conductive metal oxide.

In preferred embodiments of the reforming catalyst of the invention, the substrate material is composed of one or more substances of the following group: ZnO, TiO₂, Fe₂O₃, LiFeO₂, Mn₂O₃, and SnO₂.

In an alternative embodiment, the substrate material can consist of a water-adsorbent material that is doped with impurity ions.

The substrate material can consist of one or more substances of the group comprising aluminum-doped zinc oxide (AZO), indium-doped tin oxide (ITO), or antimony-doped tin oxide (ATO).

The catalyst material preferably consists of nickel.

In a preferred embodiment of the invention, the particles of catalyst material are present in the form of small islands on the substrate material.

The size of the small islands of catalyst material is preferably on the order of a few nanometers.

In a preferred embodiment of the invention, the catalyst is produced in the form of a layer.

In an advantageous variant of this embodiment, the catalyst is produced in the form of a flat film-like material.

In another advantageous variant of this embodiment, the catalyst is produced in the form of a coating applied on a component of the fuel cell.

In this regard, the coating that forms the catalyst can be applied especially to a current collector of the fuel cell.

In an alternative variant, the coating that forms the catalyst can be applied to a bipolar separator of the fuel cell.

In addition, the invention creates a method for producing an electronically conductive reforming catalyst of the aforementioned type. In accordance with the invention, a slurry or a paste is produced from the substrate material that supports the catalyst material, the slurry or paste is formed into a layer, and the layer is sintered.

Preferably, the layer can be formed by film casting, dipping, spraying, rolling, or application by a doctor blade.

In one embodiment of the method of the invention, the sintering of the layer can be carried out outside the fuel cell during the production process as a separate step of the method.

In another embodiment of the method of the invention, the sintering of the layer can be carried out in situ when the fuel cell is started up with the catalyst already incorporated in the fuel cell.

Finally, the invention creates a fuel cell, especially a molten carbonate fuel cell, with a reforming catalyst of the type specified above.

Specific embodiments of the invention are explained below with reference to the drawings.

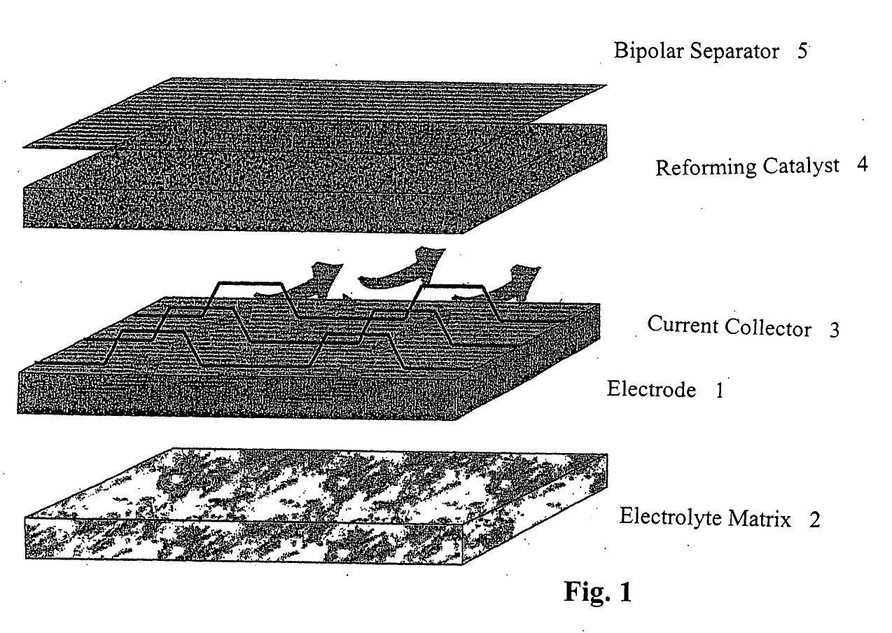

FIG. 1 shows an exploded schematic perspective view of the half-cell of a molten carbonate fuel cell in accordance with an embodiment of the invention.

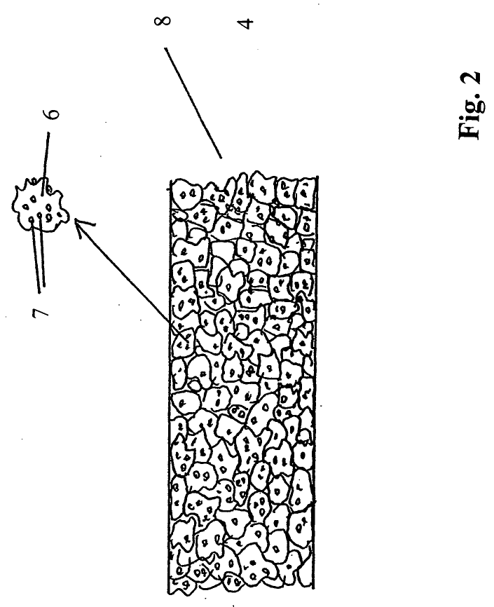

FIG. 2 shows a highly magnified and highly schematic cross-sectional view of a reforming catalyst in accordance with an embodiment of the invention.

In the half-cell of a molten carbonate fuel cell illustrated in FIG. 1, an electrode 1 (anode) is provided on one side of an electrolyte matrix 2. On the other side of the electrode 1, there is a current collector 3, which can consist of a conductive foam or an expanded metal structure and is shown in a highly schematic form in FIG. 1. A catalyst layer 4 is provided on the other side of the current collector 3. The catalyst layer 4 consists of a reforming catalyst for internal reforming of the fuel gas supplied to the half-cell. A bipolar separator 5 is provided on the other side of the catalyst 4. It separates the illustrated (anode-side) half-cell from a (cathode-side) half-cell (not shown) of another fuel cell and provides for their electrical contact. Large numbers of these half-cells are typically provided in a fuel cell stack.

The highly magnified and highly schematic cross-sectional view of FIG. 2 shows that the reforming catalyst 4 contains a layer 8 that consists of particles of a substrate material 6, on which particles of a catalyst material 7 are located. The substrate material is highly water-adsorbent and is electronically conductive. The specific conductivity of the whole reforming catalyst 4 should exceed 1 S/cm under operating conditions.

The substrate material 6 is composed of an electronically conductive metal oxide, for example, one or more substances of the group comprising ZnO, TiO₂, Fe₂O₃, LiFeO₂, Mn₂O₃, and SnO₂.

Alternatively, the substrate material can consist of a water-adsorbent material that is doped with impurity ions, for example, one or more substances of the group comprising aluminum-doped zinc oxide (AZO), indium-doped tin oxide (ITO), or antimony-doped tin oxide (ATO).

The catalyst material 7 consists of nickel. The particles of catalyst material 7 are present in the form of small islands on the substrate material 6. The size of the small islands of catalyst material 7 is on the order of a few nanometers.

The reforming catalyst 4 is preferably produced by producing a slurry or paste from the substrate material 6 that supports the catalyst material 7, forming the slurry or paste into a layer 8, and sintering the layer 8 to form a bond. The layer 8 can be formed by film casting, dipping, spraying, rolling, or application by a doctor blade. The sintering of the layer 8 can be carried out outside the fuel cell during the production process as a separate step of the method, or it can be carried out in situ when the fuel cell is started up with the catalyst 4 already incorporated in the fuel cell.

In the embodiments illustrated here, the catalyst 4 is produced in the form of a layer 8. This layer 8 can form an individual flat film-like material, or the layer can be applied in the form of a coating on a component of the fuel cell, for example, on the current collector 3 or the bipolar separator 5 (cf. FIG. 1).

A highly active electronically conductive reforming catalyst for internal reforming in a fuel cell, especially a molten carbonate fuel cell, is created by the invention.

### List of Reference Numbers

1 electrode
2 electrolyte matrix
3 current collector
4 reforming catalyst
5 bipolar separator
6 substrate material
7 catalyst material
8 layer

1-19. (canceled)

20. A molten carbonate fuel cell comprising: a bipolar separator; an anode current collector; and an electronically conductive reforming catalyst, which is arranged between the bipolar separator and the anode current collector and contains particles of a water-adsorbent substrate material and particles of a catalyst material located on the substrate material, whereby the substrate material itself provides an electronically conductive connection between the bipolar separator and the anode current collector.

21. The molten carbonate fuel cell in accordance with claim 20, wherein the reforming catalyst has a specific conductivity that exceeds 1 S/cm under operating conditions.

22. The molten carbonate fuel cell in accordance with claim 20, wherein the substrate material is composed of an electronically conductive metal oxide.

23. The molten carbonate fuel cell in accordance with claim 22, wherein the substrate material is composed of at least one substance of the group consisting of ZnO, TiO₂, Fe₂O₃, LiFeO₂, Mn₂O₃, and SnO₂.

24. The molten carbonate fuel cell in accordance with claim 20, wherein the substrate material is a water-adsorbent material that is doped with impurity ions.

25. The molten carbonate fuel cell in accordance with claim 24, wherein the substrate material consists of at least one substance of the group consisting of aluminum-doped zinc oxide (AZO), indium-doped tin oxide (ITO), and antimony-doped tin oxide (ATO).

26. The molten carbonate fuel cell in accordance with claim 20, wherein the catalyst material consists of nickel.

27. The molten carbonate fuel cell in accordance with claim 20, wherein the particles of catalyst material are formed as small islands on the substrate material.

28. The molten carbonate fuel cell in accordance with claim 27, wherein the small islands of catalyst material have a size on the order of a few nanometers.

29. The molten carbonate fuel cell in accordance with claim 20, wherein the catalyst is formed as a layer.

30. The molten carbonate fuel cell in accordance with claim 29, wherein the catalyst is formed as a flat film-like material.

31. The molten carbonate fuel cell in accordance with claim 29, wherein the catalyst is formed as a coating applied on a component of the fuel cell.

32. The molten carbonate fuel cell in accordance with claim 31, wherein the coating that forms the catalyst is applied to the current collector of the fuel cell.

33. The molten carbonate fuel cell in accordance with claim 31, wherein the coating that forms the catalyst is applied to the bipolar separator of the fuel cell.

34. A method for producing an electronically conductive reforming catalyst, which is arranged between a bipolar separator and an anode current collector of a fuel cell, especially a molten carbonate fuel cell, which catalyst includes particles of a water-adsorbent substrate material, and particles of a catalyst material located on the substrate material, whereby the substrate material itself provides an electronically conductive connection between the bipolar separator and the anode current collector, the method comprising the steps of: producing a slurry or a paste from the substrate material that supports the catalyst material; forming the slurry or paste into a layer 1; and sintering the layer.

35. The method in accordance with claim 34, wherein the layer is formed by one of film casting, dipping, spraying, rolling, or application by a doctor blade.

36. The method in accordance with claim 34, wherein the sintering of the layer is carried out outside the fuel cell during production as a separate step of the method.

37. The method in accordance with claim 34, wherein the sintering of the layer is carried out in situ when the fuel cell is started up with the catalyst already incorporated in the fuel cell.
